(19) United States
(12) Patent Application Publication
(10) Pub. No.: US 2025/0264661 A1
(43) Pub. Date: Aug. 21, 2025

(54) METHOD FOR FORMING A LAYER OF SILICON DIOXIDE ON A LAYER OF SILICON NITRIDE

(71) Applicant: LioniX International BV, Enschede (NL)

(72) Inventor: Floris FALKE, Enschede (NL)

(21) Appl. No.: 19/053,777

(22) Filed: Feb. 14, 2025

Related U.S. Application Data
(60) Provisional application No. 63/554,463, filed on Feb. 16, 2024.

(51) Int. Cl. G02B 6/132; G02B 6/12

(52) U.S. Cl. CPC G02B 6/132; G02B 2006/12061

(57) ABSTRACT

In accordance with a method of forming a waveguide on a substrate, a lower core silicon nitride layer is formed on a lower cladding layer disposed on a substrate. The silicon nitride layer is patterned to define a silicon nitride waveguide core. The exposed surfaces of the silicon nitride waveguide core are oxidized to form a cap oxide. Further, an upper cladding layer is formed over the cap oxide.

### TECHNICAL FIELD

The present disclosure relates to material deposition in general and, more specifically, to formation of an optical quality layer of silicon dioxide on top of a layer of optical quality silicon nitride.

### BACKGROUND

A Planar Lightwave Circuit (PLC) is an optical system comprising one or more integrated-optics-based waveguides that are disposed on the surface of a substrate, where the waveguides are typically combined to provide complex optical functionality. These “surface waveguides” (referred to hereinafter simply as “waveguides”) typically include a core of a first material that is surrounded by a cladding comprising a second material having a refractive index that is lower than that of the first material. The change in refractive index at the interface between the materials enables internal reflection of light propagating through the core, thereby guiding the light along the length of the waveguide.

A particularly useful waveguide structure includes a multilayer core comprising a central core located between lower and upper cores, where the central core is a thin layer of silicon dioxide (SiO₂) and the lower and upper cores are made of silicon nitride (Si₃N₄). Examples of such waveguides, commonly referred to as TriPlex™ Waveguides, are described in detail in U.S. Pat. Nos. 7,146,087 and 7,142,759, each of which incorporated herein by reference.

In these geometries, each of the silicon dioxide and silicon nitride is formed through an LPCVD process, in which the silicon dioxide is formed via decomposition of the tetraethyl orthosilicate (TEOS) and other gasses (referred to herein as “TEOS deposition”). In some cases, silicon dioxide is formed via a different process, such as LPCVD deposition in which a layer is formed out of two composing gasses, such as dichlorosilane (SiH₂Cl₂) and nitrous oxide N₂O, and the like. Although some of these processes can produce a high-quality silicon dioxide, their deposition rates are generally considered too slow for use in a commercial production application.

Unfortunately, silicon dioxide formed via TEOS deposition is typically not stable as it has low density, is vulnerable to in-diffusion of pollutants, and the like. As a result, it is necessary to perform a high-temperature (1150° C. or higher) anneal as quickly as possible after deposition to stabilize the layer. During this anneal step, the layer densifies and alters its constituent stress from tensile to compressive. Furthermore, even after annealing, a deposited silicon dioxide layer normally has large thickness non-uniformity (as much as 2-3%) over a wafer.

Once it has been annealed, the silicon dioxide layer is chemically stable; however, its material characteristics are still relatively poor compared to LPCVD silicon nitride and thermally grown silicon dioxide. For example, the refractive index of the annealed material can be quite non-uniform over the surface of a wafer, as compared to thermally grown silicon dioxide layers. In addition, the surface roughness of LPCVD-deposited and TEOS-deposited silicon dioxide layers is typically substantially worse than desirable. For photonics applications, and waveguides in general, refractive index and roughness are of critical importance as they strongly affect such waveguide parameters as propagation loss, scattering loss, and the like.

Still further, each transfer of a substrate from one deposition system to another during formation of a multilayer core dramatically increases the likelihood that particles or other impurities will be incorporated into the layer stack. The additional handling associated with these transfers also increases the likelihood that the substrates will be damaged or broken, thereby decreasing yield and increasing cost.

A method for forming a silicon dioxide layer on a silicon nitride layer that results in high optical quality and that reduces handling requirements would be a welcome advance in the state of the art.

### SUMMARY

The present disclosure is directed toward the formation of integrated-optics surface waveguides having a core that includes a layer of silicon dioxide disposed on a layer of silicon nitride.

An advance over the prior art is realized by forming a waveguide core having at least one oxidized nitride surface, which is formed by oxidizing the exposed surface(s) of a silicon nitride structure to form a silicon dioxide layer. The resultant silicon dioxide layer has a highly uniform thickness, uniform refractive index, and very low surface roughness, as compared to an equivalent LPCVD-deposited or TEOS-deposited silicon dioxide layer. The oxidation is performed at high temperature and, typically, using wet oxidation.

An illustrative embodiment is a method for forming a waveguide on a substrate, where the waveguide has a central core of silicon nitride whose top surface and sidewalls have been oxidized to form a cap oxide comprising three oxidized nitride surfaces.

The method begins with the LPCVD deposition of a layer of silicon nitride onto the lower cladding layer of silicon dioxide that is disposed on a conventional silicon wafer. The layer of silicon nitride is then patterned to define the shape of a nascent waveguide core of a strip waveguide and the wafer is transferred from the LPCVD deposition furnace to an annealing furnace configured to enable wet oxidation of all exposed silicon nitride surfaces. In some embodiments, the layer of silicon nitride is patterned to define a different waveguide core structure, such as that of a ridge waveguide, etc.

Wet oxidation of the silicon nitride is then performed, converting the top surface and sidewalls of the nascent core into oxidized nitride surfaces that collectively define a cap oxide. During formation of the cap oxide, some of the silicon nitride of the nascent core is consumed such that, once the cap oxide is formed, the resultant silicon nitride core has its desired dimensions.

The waveguide is then completed with the formation of an upper cladding over the waveguide core.

In some embodiments, a waveguide includes a multilayer core that is disposed between lower and upper cladding layers. The cladding layers comprise silicon dioxide, while the multilayer core includes a lower core of silicon nitride, a central core of silicon dioxide, and an upper core of silicon nitride, where the central core is an oxidized nitride surface formed on the lower core. The multilayer core is typically configured such its constituent layers collectively support propagation of a single-mode light signal.

The central core is formed by oxidizing the silicon nitride of the lower core to form an oxidized nitride surface that functions as the central core.

After formation of the silicon dioxide layer of the central core, a second silicon nitride layer is deposited on the silicon dioxide via LPCVD deposition to form the upper core. In some embodiments, the silicon nitride of the upper core is oxidized to form a second oxidized nitride layer.

### BRIEF DESCRIPTION OF THE DRAWINGS

FIG. 1 depicts a schematic drawing of a cross-sectional view of an illustrative embodiment of a waveguide in accordance with the present disclosure.

FIG. 2 depicts operations of a method suitable for forming a waveguide in accordance with the present disclosure.

FIG. 3 depicts a schematic drawing of a cross-sectional view of an alternative embodiment of a waveguide in accordance with the present disclosure.

FIG. 4 depicts operations of a method suitable for forming a waveguide in accordance with the present disclosure.

FIG. 5A depicts a schematic drawing of a cross-sectional view of a portion of nascent waveguide 400′ after formation of lower core layer 502.

FIG. 5B depicts a schematic drawing of a cross-sectional view of a portion of nascent waveguide 400′ after formation of central core layer 506.

FIG. 5C depicts a schematic drawing of a cross-sectional view of a portion of nascent waveguide 400′ after formation of upper core layer 508.

FIG. 5D depicts a schematic drawing of a cross-sectional view of a portion of nascent waveguide 400′ after formation of oxidized nitride surface 310.

### DETAILED DESCRIPTION

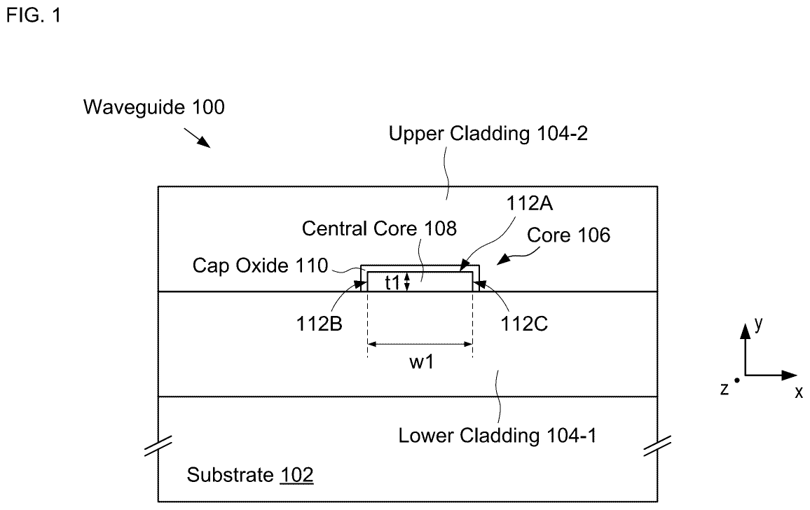

FIG. 1 depicts a schematic drawing of a cross-sectional view of an illustrative embodiment of a waveguide in accordance with the present disclosure. Waveguide 100 is a single-core waveguide that includes substrate 102, lower cladding 104-1, core 106, and upper cladding 104-2. Waveguide 100 is analogous to a conventional single-stripe silicon nitride waveguide known in the prior art; however, in waveguide 100, core 106 includes both a central core (i.e., central core 108) and cap oxide 110, the inclusion of which gives rise to improved propagation characteristics as compared to prior art silicon nitride waveguides, as discussed below.

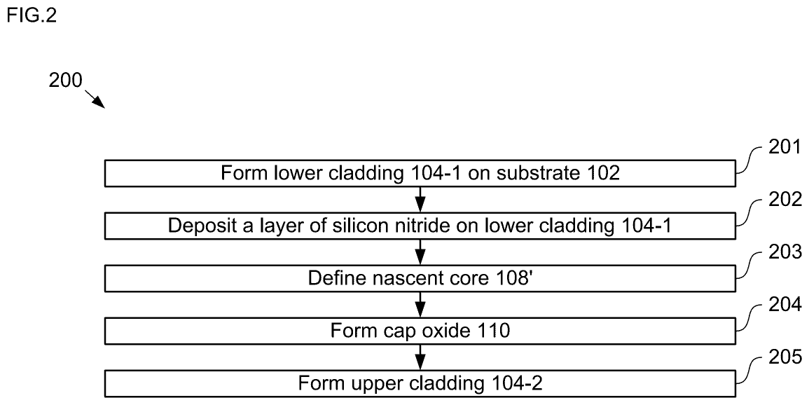

FIG. 2 depicts operations of a method suitable for forming a waveguide in accordance with the present disclosure. Method 200 begins with operation 201, wherein lower cladding 104-1 is formed on substrate 102.

Substrate 102 is a conventional silicon wafer suitable for planar processing. In some embodiments, substrate 102 is a different substrate suitable for planar processing, such as a glass substrate, compound semiconductor substrate, and the like.

Lower cladding 104-1 is a conventional cladding layer comprising material suitable for use as a cladding layer for core 106. In the depicted example, the cladding material is silicon dioxide; however, any suitable material can be used in one or both of lower cladding 104-1 and upper cladding 104-2 without departing from the scope of the present disclosure. Preferably, lower cladding 104-1 has a thickness suitable for mitigating coupling of optical energy from core 106 into substrate 102. Typically, the thickness of lower cladding 104-1 is at least three microns.

At operation 202, a layer of silicon nitride is deposited on lower cladding 104-1. In the depicted example, the first layer of silicon nitride is deposited via LPCVD deposition such that it has an initial thickness of 250 nm. In some embodiments, a silicon nitride layer having a different thickness is deposited on lower cladding 104-1.

At operation 203, nascent central core 108′ is defined by etching the layer of silicon nitride via a conventional reactive ion etch (RIE). Nascent core 108′ is defined such that it has an initial width of 1.06 microns.

At operation 204, cap oxide 110 is formed by oxidizing the silicon nitride of all exposed surfaces of nascent central core 108′ (i.e., both sidewalls and its top surface), thereby forming oxidized-nitride surfaces 112A, 112B, and 112C. In the depicted example, cap oxide 110 is grown on the first layer of silicon nitride in an annealing furnace configured to enable wet oxidation at 1150° C.; however, higher or lower temperatures can be used without departing from the scope of the present disclosure. A typical growth rate at 1150° C. is approximately ½ nm per minute. In some embodiments, cap oxide is grown via dry oxidation; however, the growth rate using dry oxidation is normally too slow to be practical for many applications.

It should be noted that, during the oxidation of nascent central core 108′, some of its silicon nitride is consumed at exposed surfaces to form silicon dioxide. Typically, approximately 60% of the resultant silicon dioxide layer is formerly silicon nitride. In other words, the formation of approximately 5 nm of silicon dioxide consumes approximately 3 nm of silicon nitride.

It should be further noted that wet oxidation enables the growth of very high-quality silicon dioxide layers from silicon nitride layers with very controlled and very uniform growth rate of several nm per hour. The oxidation process is facilitated by the fact that free oxygen can diffuse more easily through the silicon dioxide layer as it forms than through the remaining, underlying silicon nitride material.

In the depicted example, cap oxide 110 is grown to a thickness of 50 nm. As a result, approximately 30 nm of silicon nitride is consumed at each exposed surface of central core 108 such that it has a final thickness t1 of 220 nm and final width w1 of 1.00 microns, which determine the propagation characteristics of waveguide 100. Upon completion of the oxidation process, core 106 includes oxidized-nitride surfaces 112A, 112B, and 112C, each having a thickness of approximately 50 nm. In some embodiments, a waveguide core has a different thickness and/or width. In some embodiments, a core includes an oxidized surface having a different thickness.

It is an aspect of the present disclosure that silicon dioxide grown by oxidation of silicon nitride is significantly structurally different from silicon dioxide deposited using conventional methods, such as LPCVD deposition, TEOS deposition, spin-on deposition, and the like. As a result, an oxidized-nitride surface is structurally different than a layer of silicon dioxide that has been deposited on a silicon nitride surface. Specifically, as compared to deposited silicon dioxide, silicon dioxide grown by oxidizing silicon nitride is:
inherently denser—in some cases, even after the deposited silicon dioxide has been annealed;
is chemically different, since deposited silicon dioxide typically includes at least trace amounts of constituent chemicals of the precursor gasses used in its deposition; and
has higher purity, since an as-deposited silicon dioxide layer has low density that allows the incorporation of impurities during the time between its deposition and when it is annealed.

Furthermore, the use of thermal oxidation to grow silicon dioxide from the exposed surfaces of the first silicon nitride layer affords embodiments in accordance with the present disclosure with several important advantages over the prior art, including:
i. better thickness uniformity for the resultant silicon dioxide layer; or
ii. improved refractive-index uniformity of the resultant silicon dioxide layer; or
iii. a silicon dioxide layer having lower surface roughness; or
iv. a reduction in the handling requirements and less particle-incorporation in the completed waveguide due to the elimination of one wafer transfer since oxidation is performed in the same chamber used to anneal the first silicon nitride layer; or
v. reduced fabrication time; or
vi. any combination of i, ii, iii, iv, and v.

Table 1 below shows the measured surface-roughness of four different thicknesses of silicon dioxide grown out of a Si₃N₄ layer with a thickness of ˜180 nm. As can be seen from Table 1, as the thickness of the silicon dioxide increases, surface roughness decreases.

TABLE 1
Measured surface roughness of oxidized silicon nitride surfaces
having silicon dioxide layer of different thicknesses.
As a reference, the surface roughness of a bare silicon
wafer analogous to those on which the different silicon
dioxide layers were formed was measured as 156 pm.

| | | Surface Roughness |
|---|---|---|
| Oxidation Time | Oxide Thickness | Sq (square root) |
| (min) | (nm) | (pm) |
| 0 | 0 | 323 |
| 30 | 16.7 | 272 |
| 120 | 46.6 | 201 |
| 430 | 136.1 | 195 |

It is yet another aspect of the present disclosure that, not only does a silicon dioxide layer grown on a silicon nitride layer have better surface roughness than equivalent deposited silicon dioxide layers, but the growth of the silicon dioxide improves the surface roughness of the silicon nitride surface on which the silicon dioxide has been grown as well.

Table 2 below shows the measured surface-roughness of the silicon nitride on which four different thicknesses of silicon dioxide are grown. The measurements are taken after the grown silicon dioxide has been chemically removed from the underlying silicon nitride. As can be seen from Table 2, as the thickness of the layer of grown silicon dioxide increases, surface roughness of the underlying silicon nitride also decreases.

TABLE 2
Measured surface roughness of silicon nitride surfaces that have been
oxidized to form silicon dioxide layers of different thicknesses.

| | | Surface Roughness |
|---|---|---|
| Oxidation Time | Nitride Thickness | Sq (square root) |
| (min) | (nm) | (pm) |
| 0 | 176 | 292 |
| 30 | 166 | 256 |
| 120 | 149 | 240 |
| 430 | 96 | 248 |

As a result, the improved surface roughness of the sidewalls and top surface of central core 106 enables integrated-optics-based waveguides in accordance with the present disclosure to have significantly lower propagation loss that waveguides of the prior art, since much of the propagation loss of a typical prior-art waveguide arises due to scattering loss at the interfaces between its core and its cladding layers.

At operation 205, waveguide 100 is completed with the deposition of upper cladding 104-2 in conventional fashion. Upper cladding 104-2 is analogous to lower cladding 104-1. As will be understood by one skilled in the art, after reading this Specification, once upper cladding 104-2 is formed, cap oxide 110 functions as a portion of the upper cladding of waveguide 100.

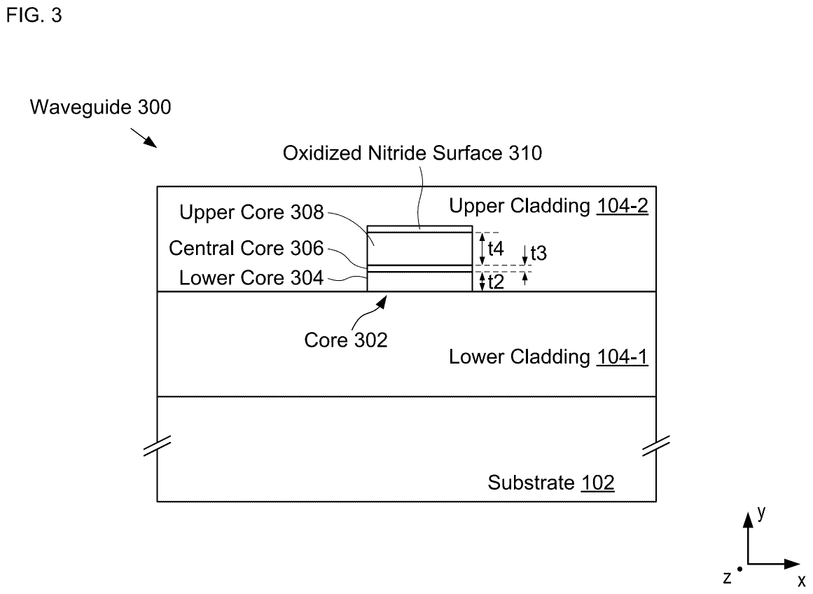

FIG. 3 depicts a schematic drawing of a cross-sectional view of an alternative embodiment of a waveguide in accordance with the present disclosure. Waveguide 300 includes substrate 102, lower cladding 104-1, core 302, and upper cladding 104-2. Waveguide 300 is a type of waveguide referred to as a TripleX™ waveguide, examples of which are described in detail in U.S. Pat. Nos. 7,146,087 and 7,142,759, each of which incorporated herein by reference.

In the depicted example, waveguide 300 is an asymmetrical double-stripe waveguide such that core 302 comprises lower core 304, central core 306, and upper core 308, having thicknesses t2, t3, and t4, respectively. In the depicted example, thicknesses t2, t3, and t4 are selected to enable single-mode propagation of a light signal through waveguide 100. In the depicted example, t2 is 75 nm, t3 is 100 nm, and t4 is 175 nm; however, any suitable value can be used for each of these thicknesses without departing from the scope of the present disclosure.

In some embodiments, core 106 at least one of its constituent layers has a different thickness (e.g., a thickness that enables multimode propagation of a light signal).

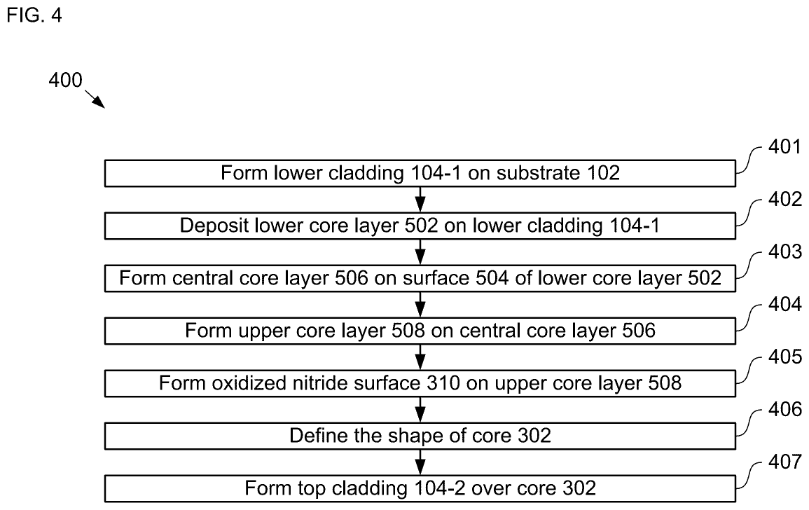

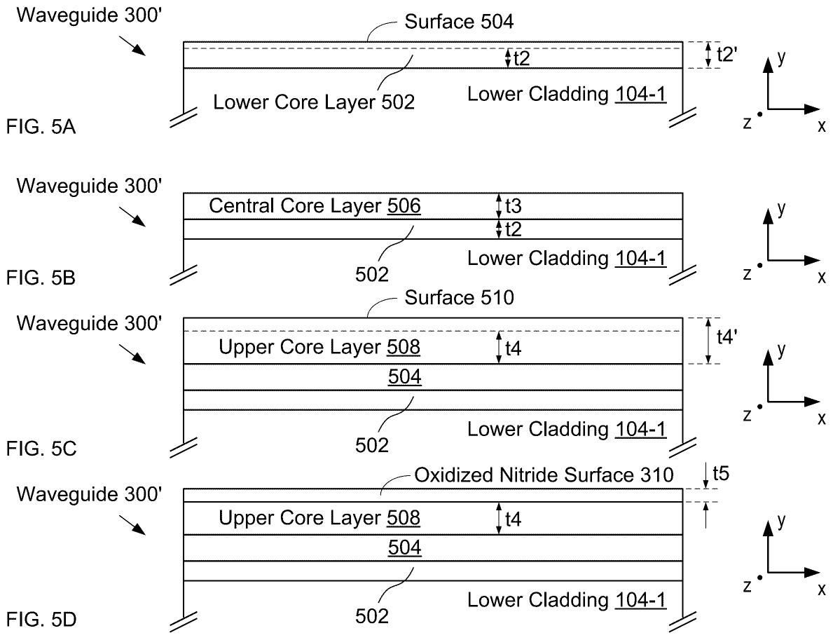

FIG. 4 depicts operations of a method suitable for forming a waveguide in accordance with the present disclosure. Method 400 is described with continuing reference to FIG. 3, as well as reference to FIGS. 5A-C.

Method 400 begins with operation 401, wherein lower cladding 104-1 is formed on substrate 102 as discussed above.

At operation 402, lower core layer 502 is formed on lower cladding 104-1. In the depicted example, lower core layer 502 is a layer of silicon nitride formed via LPCVD deposition such that it has an initial thickness, t2′, which is equal to 135 nm.

FIG. 5A depicts a schematic drawing of a cross-sectional view of a portion of nascent waveguide 400′ after formation of lower core layer 502.

At operation 403, exposed top surface 504 of lower core layer 502 is oxidized to form central core 506, as discussed above and with respect to operation 204.

In the depicted example, central core layer 506 is grown such that it has thickness, t3, equal to 100 nm. As noted above, the growth of 100 nm of oxide on top surface 504 consumes approximately 60 nm of lower core layer 502 leaving the lower core layer with a final thickness, t2, of approximately 75 nm.

FIG. 5B depicts a schematic drawing of a cross-sectional view of a portion of nascent waveguide 400′ after formation of central core layer 506.

At operation 404, upper core layer 508 is deposited on central core layer 506. In the depicted example, upper core layer 508 is a layer of silicon nitride formed via LPCVD deposition such that it has an initial thickness, t4′, which is equal to 205 nm.

FIG. 5C depicts a schematic drawing of a cross-sectional view of a portion of nascent waveguide 400′ after formation of upper core layer 508.

At operation 405, exposed top surface 510 of upper core layer 508 is oxidized to form oxidized nitride surface 310, which is analogous to oxidized nitride surface 112A. In the depicted example, oxidized nitride surface 310 is grown such that it has a thickness, t5, equal to 50 nm. This oxidation consumes approximately 30 nm of upper core layer 508, leaving it with a final thickness, t4, of 175 nm.

FIG. 5D depicts a schematic drawing of a cross-sectional view of a portion of nascent waveguide 400′ after formation of oxidized nitride surface 310.

At operation 406, lower core layer 502, central core layer 506, upper core layer 508, and oxidized nitride surface 310 are etched to laterally define the shape of core 302. In the depicted example, these layers are etched such that each of lower core 304, upper core 308, and oxidized nitride surface 310 have a width of 1.0 micron. Typically, these layers are etched in a conventional RIE operation; however, any suitable means of patterning the layers can be used without departing from the scope of the present disclosure.

At operation 407, top cladding 104-2 is formed over core 302 to complete the fabrication of waveguide 300. As noted above, oxidized nitride surface 310 is substantially subsumed by upper cladding 104-2 such that it functions as a small part the upper cladding once it is formed.

In some embodiments, operations 405 and 406 are reversed such that the nitride sidewalls of lower core 304, central core 306, and upper core 308 are exposed during the oxidation step. As a result, the widths of lower core 304 and upper core 308 are reduced slightly from their widths after the etching of lower core layer 502, central core layer 506, and upper core layer 508. In some embodiments, this reduction of the widths of the lower and upper core layers is accounted for by appropriate mask design.

For example, in an exemplary embodiment wherein a final width of 1.0 micron is desired for core 302, each of lower core 304 and upper core 308 is defined such that it has a nascent width of 1.06 micron before oxidation of their exposed surfaces of silicon nitride. A subsequent oxidation to form an oxidized nitride surface having a thickness of 50 microns, therefore, reduces the widths of lower core 304 and upper core 308 to the desired final thickness of 1.0 micron.

The improved surface roughness at the interfaces between the constituent sub-layers of core 302 enables multilayer core waveguides in accordance with the present disclosure to have significantly lower propagation loss that waveguides of the prior art, since smoother interfaces mitigate scattering loss, as discussed above.

In addition to improving the propagation characteristics of a waveguide, the growth of silicon dioxide on one or more exposed silicon nitride surfaces can also be exploited to improve other integrated-optics devices.

Specifically, it is an aspect of the present disclosure that, by exploiting the fact that oxidizing a silicon nitride structure consumes some of the silicon nitride, methods in accordance with the present disclosure can be used to fine tune the characteristics of silicon nitride-based spotsize converters, such as those described in U.S. Pat. Nos. 8,718,432, 9,268,089, 9,939,582, and 9,020,317, each of which is incorporated herein by reference.

In some embodiments, a lateral taper is defined in the lateral dimensions of a silicon nitride-based waveguide core in accordance with the present disclosure. Once the lateral taper is defined, the exposed surfaces of the silicon nitride are oxidized, which consumes some of the silicon nitride of the taper region, thereby sharpening the taper.

For example, for the multilayer core structure of waveguide 300, during operation 406, a lateral taper can be defined in the waveguide structure. Unfortunately, for an adiabatic taper, the width typically needs to be reduced to 0.2-0.5 micron, and very high precision is required in width as well as the layer thicknesses of its constituent layers. This is difficult to achieve, requires very expensive ultra-high-resolution ultraviolet lithography, and very well controlled reactive ion etching.

However, since the oxidation of any exposed silicon nitride consumes some of the silicon nitride material itself, the outer parts of the nitride core portions are oxidized significantly faster than in the center of the waveguide, since the oxidation in these regions proceeds from both the top surface and the exposed sidewalls. This results in a tapered profile in two dimensions. In case of a very narrow waveguide, such as at the tip of a spotsize convertor, the oxidation process is substantially uniform over the entire width of the waveguide core, where good control is most advantageous. In regions of a spotsize convertor in which the waveguide core has its typical width (e.g. 1.1-1.4 micron, etc.) oxidation is more “tapered” over the width of the channel waveguide, which can be readily compensated by appropriate waveguide design.

As a result, taper width values as small as 50-200 nm and layer thicknesses as thin as tens of nanometers can be readily achieved without the need for expensive equipment or processes. In fact, in some embodiments, complete oxidation of lower core 304 can be achieved to convert the remaining waveguide structure into a single-stripe waveguide core that can more easily be optically coupled to an external element, such as an optical fiber.

Methods in accordance with the present disclosure, therefore, enable creation of accurately defined spotsize convertors with extremely thin, yet very accurately defined, nitride layer values and ultra small waveguide width levels while employing standard, basic geometries and conventional low-cost lithography equipment.

In addition, the teachings herein enable the application of a post-processing wet oxidation step to fine tune characteristics of spotsize convertors after full wafer processing but before metallization. In some cases, grating couplers can be included to enable full-wafer chip inspection, determination of the modal characteristics of spotsize convertors or other components, after which, an additional oxidation can be performed to fine tune the characteristics of these components.

It is to be understood that the disclosure teaches just some examples of embodiments in accordance with the present invention and that many variations of embodiments in accordance with the present disclosure can easily be devised by those skilled in the art after reading this disclosure and that the scope of the present invention is to be determined by the following claims.

What is claimed is:

1. A method of forming a waveguide on a substrate, comprising:
forming a lower core silicon nitride layer on a lower cladding layer disposed on a substrate;
patterning the silicon nitride layer to define a silicon nitride waveguide core;
oxidizing exposed surfaces of the silicon nitride waveguide core to form a cap oxide; and
forming an upper cladding layer over the cap oxide.

2. The method of claim 1 wherein the silicon nitride layer is formed by LPCVD deposition.

3. The method of claim 1 wherein oxidizing the exposed surfaces of the silicon nitride waveguide core includes a wet oxidation process.

4. A waveguide formed in accordance with the method of claim 1.

5. A method of forming a waveguide on a substrate, comprising;
forming a lower core silicon nitride layer on a lower cladding layer disposed on a substrate;
oxidizing a surface of the lower core silicon nitride layer to form a central core silicon dioxide layer;
forming an upper core layer on the lower core silicon nitride layer.
forming an upper cladding layer over the lower core silicon nitride layer.

6. The method of claim 1 wherein the upper core layer is an upper core silicon nitride layer.

7. The method of claim 6 prior to formation of the upper cladding layer, oxidizing a surface of the upper core silicon nitride layer to form an oxidized nitride surface.

8. The method of claim 7 further comprising patterning the lower core silicon nitride layer, the central core silicon dioxide layer, the upper core silicon nitride layer and the oxidized nitride surface to define a multi-core waveguide structure.

9. The method of claim 7 prior to oxidizing the surface of the upper core silicon nitride layer, patterning the lower core silicon nitride layer, the central core silicon dioxide layer and the upper core silicon nitride layer to define a multi-core waveguide structure.

10. The method of claim 5 wherein the lower core silicon nitride layer is formed by LPCVD deposition.

11. The method of claim 5 wherein oxidizing the surface of the lower core silicon nitride waveguide includes a wet oxidation process.

12. A waveguide formed in accordance with the method of claim 5.

13. A waveguide, comprising:
a substrate;
a lower cladding layer disposed on a substrate;
a lower core silicon nitride layer disposed on the lower cladding layer
a central core oxidized nitride layer disposed on the lower core silicon nitride layer;
an upper core silicon nitride layer on the lower core disposed on central core silicon dioxide layer; and
an upper cladding layer over the upper core silicon nitride layer.

14. The waveguide of claim 13 wherein the lower cladding layer and the upper cladding layers each comprise silicon dioxide.

15. The waveguide of claim 13 wherein the lower core silicon nitride layer, the central core oxidized nitride layer and the upper core silicon nitride layer have thicknesses that enable single mode propagation of a light signal.
